(19) United States
(12) Patent Application Publication
(10) Pub. No.: US 2012/0091778 A1
(43) Pub. Date: Apr. 19, 2012

(54) APPARATUS FOR MAINTAINING THE HEAD OF A PERSON IN AN ERECT POSITION WHEN THE PERSON IS SITTING IN A SEAT

(76) Inventors: MARTHA JOHNSON, Meridian, MS (US); Shannon Baker, Meridian, MS (US); Apryl Blackburn, Meridian, MS (US)

(21) Appl. No.: 13/277,175

(22) Filed: Oct. 19, 2011

Related U.S. Application Data
(60) Provisional application No. 61/394,384, filed on Oct. 19, 2010.

(51) Int. Cl. A47C 7/38; B60N 2/48

(52) U.S. Cl. 297/397

(57) ABSTRACT

An apparatus is for maintaining the head of a person in an erect position when the person is sitting in a seat. The apparatus includes a clamp connected to the seat. A flexible rod is provided. A mechanism is for coupling an end of the flexible rod to the clamp. The flexible rod can be bent to extend across the forehead of the head of the person, to keep the head in the erect position especially when the person is sleeping.

### CROSS-REFERENCE TO RELATED APPLICATION

This application claims the benefit of Provisional Patent Application No. 61/394,384, filed on Oct. 19, 2010, in the United States Patent & Trademark Office, the disclosure of which is incorporated herein by reference.

### BACKGROUND OF THE INVENTION

1. Field of the Invention

The present invention relates to a head support, and more particularly, an apparatus for maintaining the head of a person in an erect position when the person is sitting in a seat.

There are many occasions where an individual may fall asleep while in a sitting position. This is especially common for children that are riding in a car seat or stroller. Adults in a wheelchair or those individuals on a lengthy car ride may also be prone to falling asleep sitting up. Typically, as a person doses off, the head tends to roll downwards or to the side. This can cause strain to the neck and/or head. It is difficult for an individual to keep their head in an erect position while they are sleeping. When they awaken, they may suffer from a stiff or sore neck. An efficient solution is necessary.

The present invention is designed to keep the head erect when an individual is sleeping in a sitting position. The apparatus can be used when sleeping in a car seat, stroller, wheelchair, or other type of seat or chair. The present invention maintains the head in an upright position, which assists in reducing or eliminating neck discomfort. It can be used by individuals of all ages, but is especially ideal for children.

2. Description of the Prior Art

Numerous innovations for head restraints have been provided in the prior art that will be described. Even though these innovations may be suitable for the specific individual purposes to which they address, however, they differ from the present invention.

A FIRST EXAMPLE, U.S. Pat. No. 4,607,885, Issued on Aug. 26, 1986, to del Fierro teaches a head restraining device for preventing possibly injurious forward and lateral motion of the head of a child seated in a child's seat, such device comprising a rigid U-shaped restraining member which surrounds the forward and lateral portions of the child's head, and is of a size to be separated therefrom by a slight air gap so as to not be uncomfortable yet be capable of being engaged by the child's head and restraining such from any more than minimal forward and lateral motion. A flexible tether removably and adjustably anchors the head restraint to the back of the child's seat at any selected height. With the restrainer thus anchored, support members at the ends thereof aid in maintaining the restrainer rigid with respect to the front surface of the seat back and preventing the device from slipping out of place relative to the child's head.

A SECOND EXAMPLE, U.S. Pat. No. 4,707,031, Issued on Nov. 17, 1987, to Meistrell teaches a head support for a traveler sitting in a chair having a headrest, and which includes: a first band adapted to be fitted in adjustably wrapped condition closely about the user's head and at eye or forehead level, a band retention structure associated with the band for retaining the band in said wrapped condition, and a head restraint structure coupled to the band and adapted to be coupled to the headrest for restraining the user's head against lateral side-to-side movement relative to the headrest.

A THIRD EXAMPLE, U.S. Patent Office Publication No. 2002/0043859, Published on Apr. 18, 2002, to Smith teaches a child's sleep collar for use with a child safety seat that includes a pair of collar supports, forming a left and a right collar support. Each of the collar supports has a body, an attachment end, and a coupling end. The attachment end includes an attachment strap and is designed to attach respectively to a left or right belt positioning clip of a child safety seat. The coupling end of each collar support forms a generally planar surface and has a left or right collar fastener respectively attached to the planar surface. Each of the collar fasteners is designed to releasably engage the other collar fastener. When the collar fasteners are attached, the left planar surface faces the right planar surface. The body of each collar support includes a cushion fill material and is preferably tubular.

A FOURTH EXAMPLE, U.S. Pat. No. 7,185,378, Issued on Mar. 06, 2007, to Smith teaches an adjustable support/pad that retains any shape to which it is configured and which may be reshaped to serve another purpose. The support/pad has at least one pliable coil spring in the shape of a flexible tube capable of being bent into multiple positions and holding any of the positions until it is again bent. The coil spring is embedded in a deformable cushion to provide comfort of the body wherever the support/pad is applied. The adjustable support can be made into a neck supporting pillow, or a cushion adapted to be removably attached to the back of a chair, to support the back of a seated user.

A FIFTH EXAMPLE, U.S. Patent Office Publication No. 2010/0102604, Published on Apr. 29, 2010, to Barnes et al. teaches an encircling head restraint rigidly though movably attached to a seat within a vehicle, such that in the event of a crash or other sudden movement, the head of the occupant of the seat is protected, and excess movement of the head and neck is prevented. The encircling head restraint sits around the head, but does not touch the head so that the occupant can move the head within the encircling head restraint. The encircling head restraint prevents excess movement of the head in all directions. In a preferred embodiment the encircling head restraint is movably mounted to a child's car seat such that it can be adjusted up or down to fit properly on the head of the child. The encircling head restraint is adjustable to accommodate different sized heads. There is a hinge mechanism that allows the encircling head restraint to be easily moved out of the way to allow easy access to the seat by the occupant.

A SIXTH EXAMPLE, U.S. Pat. No. 7,740,318, Issued on Jun. 22, 2010, to Funke III et al. teaches a padded strap that is attached to both sides of a child car seat using two sets of hook and loop type fasteners, and alternatively, through use of two rotating discs. A child car seat head support system is thereby provided, which holds a baby's head in a comfortable, upright position while sleeping in a forward facing car seat. Stabilized support is accomplished using the padded strap to gently hold the child's head in an upright position against the back of the child's car seat. The support mechanism prevents the child's head from falling forward or “rolling” to the left or right side while the child is asleep. In an alternative embodiment, the padded strap is attached at both free ends to a tension strap with two sets of fasteners, respectively;

thereby forming a single, circular strap, operable for placement over the top of the car seat. The circular strap is held in position by the tension force applied by the elastic material of the padded strap, and the resulting friction applied between the circular strap and the outside of the car seat. The circumference of the circular strap may be adjusted with the two sets of fasteners, preferably hook and loop type, to accommodate various car seats, strollers, booster seats, and the like.

A SEVENTH EXAMPLE, U.S. Patent Office Publication No. 2011/0113557, Published on May 19, 2011, to Aguilera teaches a travel head support to support a traveler's head as, for example, they sleep while sitting substantially upright. By supporting the traveler's head, the travel head support of an embodiment may increase the comfort, quality, and restfulness of the traveler's sleep. In particular, by supporting the traveler's head, the travel head support of an embodiment may substantially prevent the embarrassment and/or sleep interruption of one or more hypnic jerks.

AN EIGHTTH EXAMPLE, U.S. Pat. No., 8,007,044, Issued on Aug. 30, 2011, to Dubey et al. teaches a headrest for baby to be used in baby seats and car seats. The headrest includes two conjoined soft hands which are joined to the wrist at some angle to form wide U or boat shape. The head of the baby rest into the soft conjoined hands and the chin resting on the middle/center joining part of the hands of the headrest stopping the unwanted forward movement of the head.

Cheeks and temples of the baby rests on palm and fingers of the hands which stop unwanted side to side movement of the head. Headrest has straps attached at the outer layer/back side of the conjoined hand and strap's other end is attached to the baby seat with the fastening system to hold the headrest in position.

It is apparent now that numerous innovations for head restraints have been provided in the prior art that are adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide an apparatus for maintaining the head of a person in an erect position when the person is sitting in a seat that avoids the disadvantages of the prior art.

ANOTHER OBJECT of the present invention is to provide an apparatus for maintaining the head of a person in an erect position when the person is sitting in a seat that is simple and inexpensive to manufacture.

STILL ANOTHER OBJECT of the present invention is to provide an apparatus for maintaining the head of a person in an erect position when the person is sitting in a seat that is simple to use.

BRIEFLY STATED, STILL YET ANOTHER OBJECT of the present invention is to provide an apparatus for maintaining the head of a person in an erect position when the person is sitting in a seat. The apparatus comprises a clamp connected to the seat. A flexible rod is provided. A mechanism is for coupling an end of the flexible rod to the clamp. The flexible rod can be bent to extend across the forehead of the head of the person, to keep the head in the erect position especially when the person is sleeping.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawings are briefly described as follows:

FIG. 1 is a perspective view showing the present invention having a first clamp type attached to a car seat holding a head of a child erect when sleeping in the car seat;

FIG. 2 is a perspective view of the present invention per se shown in FIG. 1;

FIG. 3 is an exploded perspective view of the present invention shown in FIG. 2;

FIG. 4 is a perspective view similar to FIG. 2, showing the present invention having a second clamp type;

FIG. 5 is a perspective view similar to FIG. 4, showing the present invention having a third clamp type;

FIG. 6 is a perspective view similar to FIG. 5, showing the present invention having a fourth clamp type; and

FIG. 7 is a perspective view of the present invention shown in FIG. 5, clamped onto a stroller.

### REFERENCE NUMERALS UTILIZED IN THE DRAWING

110 apparatus

112 head of person 114

114 person

116 seat

118 clamp of apparatus 110

120 flexible rod of apparatus 110

122 coupling mechanism of apparatus 110

124 end of flexible rod 120

126 forehead of head 112

128 collar of coupling mechanism 122

130 transverse aperture in collar 128

132 spring loaded button of coupling mechanism 122

134 foam cushion sleeve of apparatus 110

136 soft decorative cover of apparatus 110

140 C-clamp for clamp 118

142 pipe clamp for clip clamp 118

144 tubular handle of stroller 146

146 stroller

148 spring locking pliers clamp for clamp 118

### DETAILED DESCRIPTION OF THE PREFERRED EMBODIMENT

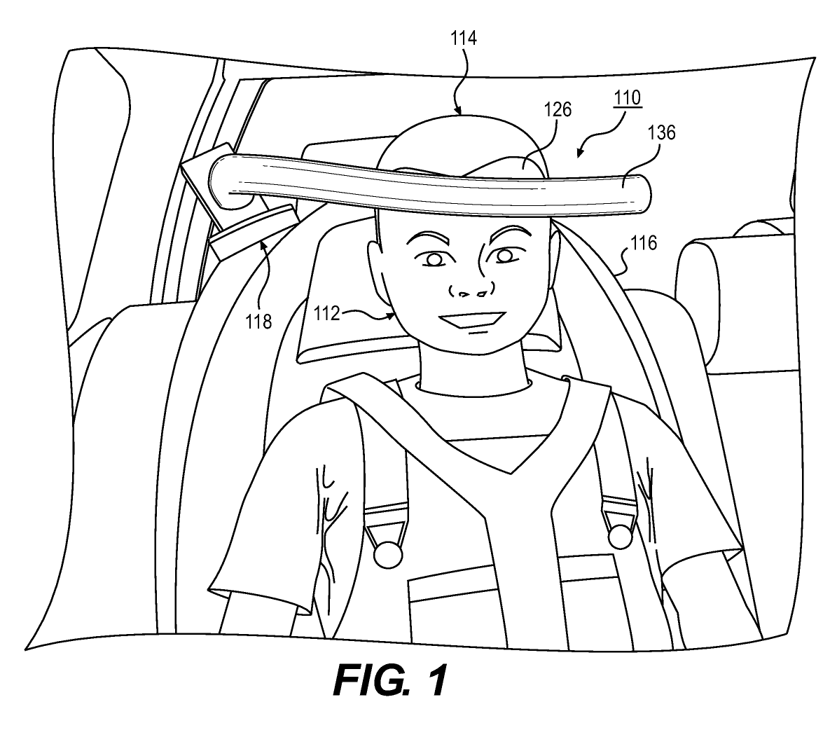

As shown in FIG. 1, the present invention is an apparatus 110 for maintaining the head 112 of a person 114 in an erect position when the person 114 is sitting in a seat 116. The apparatus 110 comprises a clamp 118 connected to the seat 116. A flexible rod 120 is provided.

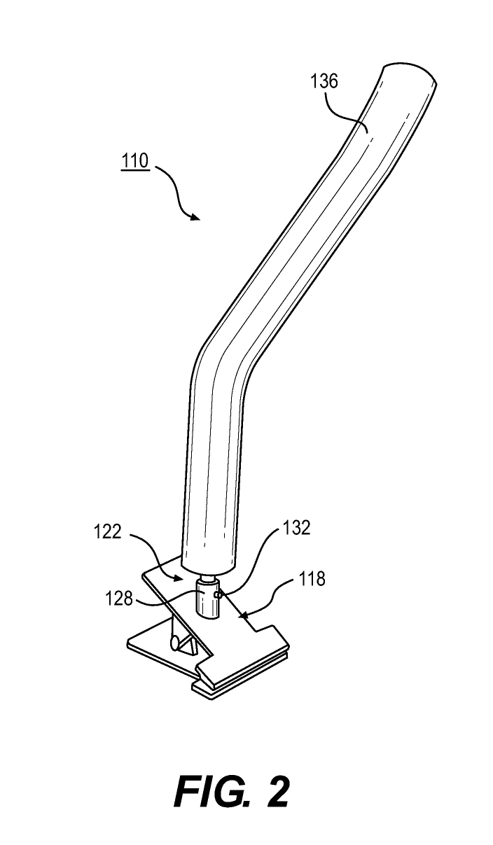

As shown in FIG. 2, a mechanism 122 is for coupling an end 124 of the flexible rod 120 to the clamp 118. The flexible rod 120 can be bent to extend across the forehead 126 of the head 112 of the person 114 to keep the head 112 in the erect position especially when the person 114 is sleeping. The person 114 is a child and the seat 116 is a car seat.

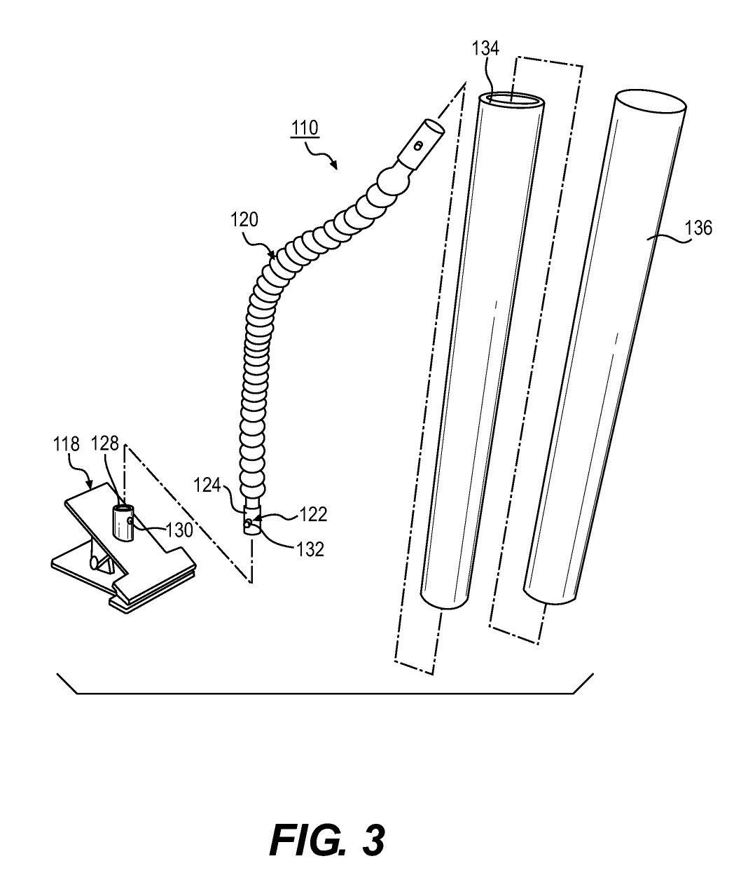

As best seen in FIG. 3, the coupling mechanism 122 comprises a collar 128 mounted on the clamp 118 having a transverse aperture 130 therethrough. A spring loaded button 132 is horizontally mounted on the end 124 of the flexible rod 120. When the end 124 of the flexible rod 120 is inserted into the collar 128 the spring loaded button 132 will snap into the transverse aperture 130 in the collar 128.

A foam cushion sleeve 134 fits over the flexible rod 120 to act as a pillow. A soft decorative cover 136 slips over the foam cushion sleeve 134. The soft decorative cover 136 can be available in a wide variety of colors and designs.

The clamp 118, as shown in FIGS. 1,2 and 3, is comprised of a spring clip clamp.

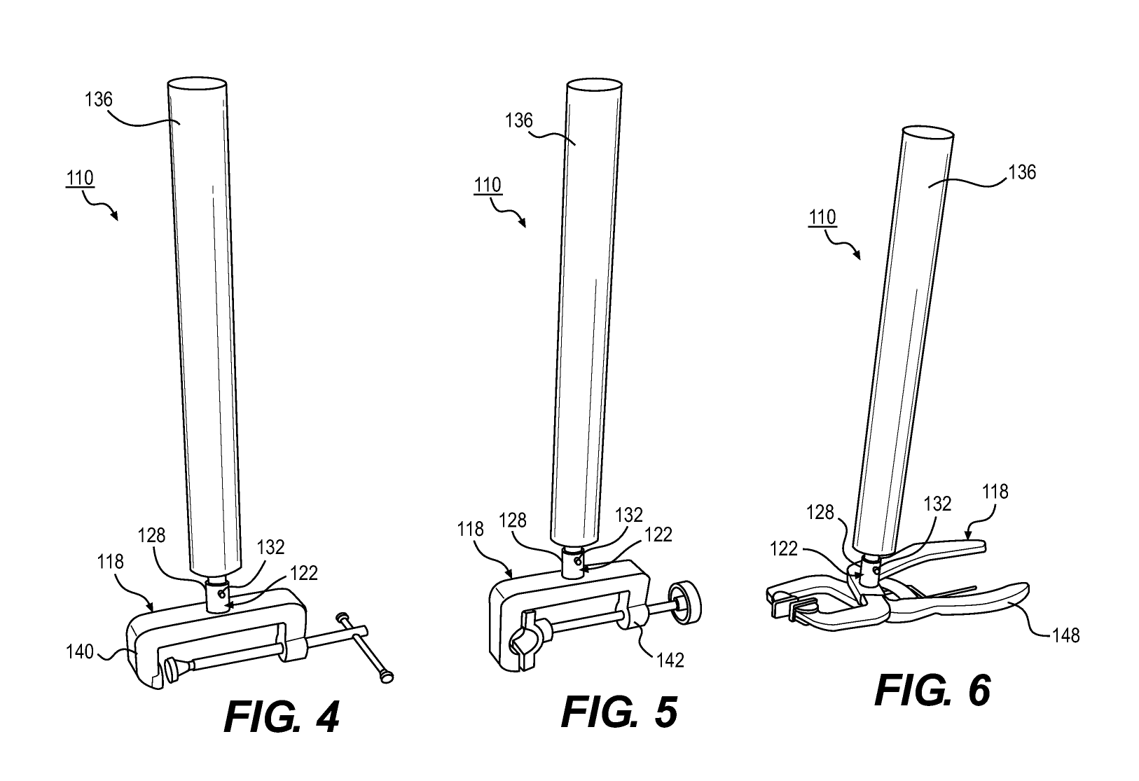

As shown in FIG. 4, the clamp 118 is comprised of a C-clamp 140.

As shown in FIG. 5, the clamp 118 is comprised of a pipe clamp 142.

As shown in FIG. 6, the clamp 118 is comprised of a spring locking pliers clamp 148.

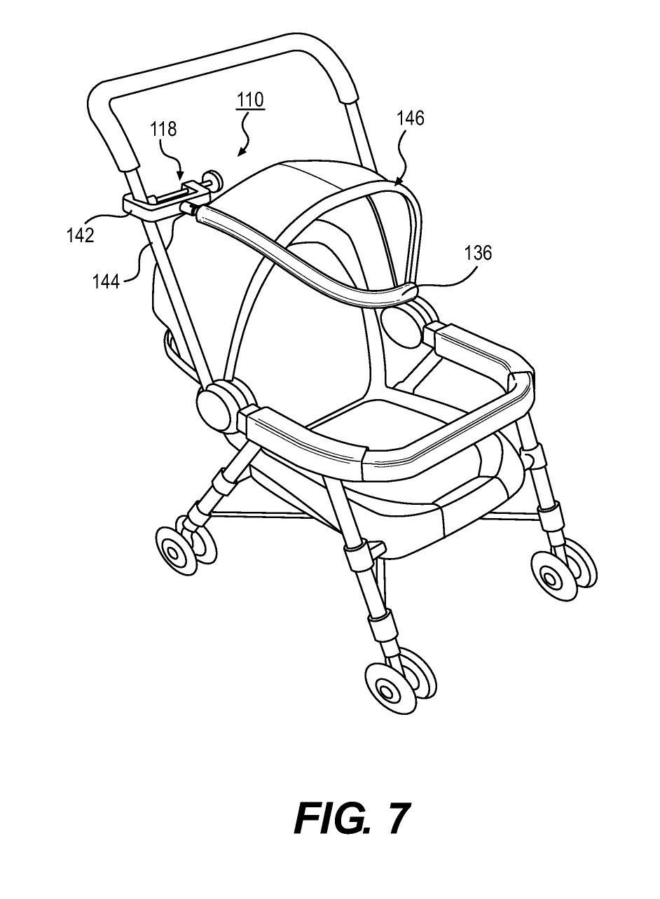

As shown in FIG. 7, the pipe clamp 142 can engage with a tubular handle 144 of a stroller 146.

In summary the apparatus 110 can be attached to a car seat, stroller 146, wheelchair, or other seat 116 in order to assist a person 114 in maintaining their head 112 in an upright position. The present invention is comprised of a flexible rod 120, which is connected to a clamp 118 by a coupling mechanism 122 having a spring-loaded button 132 on the end 124 of the flexible rod 120. The button 132 can be pushed in and snapped into place within a transverse aperture 130 in collar 128 on the clamp 118. Different clamps 118 are available for use on different types of seats 116, such as the stroller 146 and car seats. The apparatus 110 has a foam cushion sleeve 134, which will fit around the rod 120 and may be secured using hook and loop fasteners (not shown). The foam cushion sleeve 134 acts as a pillow.

A soft, decorative cover 136 slides over the foam cushion sleeve 134. The cover 136 may be available in a wide variety of colors and designs. The cover 136 may be applied using hook and loop fasteners (not shown). Clamps 118 may also be placed on both ends of the rod 120. If the apparatus 110 has two clamps 118, the cover 136 will need to have access on both ends. The cover 136 may be modified or an additional cover design may be available. The length of cover 136 (or sleeve 134) is about 2-4 feet. The cover 136 has a diameter of about 2 inches. The sleeve 134 has an outer diameter from 1.5-2 inches and inner diameter is about 1 inch. The size (thickness, width, and length) of all the clamps are about 1×2×5 inches. The exact specifications may vary.

It will be understood that each of the elements described above, or two or more together, may also find a useful application in other types of constructions differing from the types described above.

While the invention has been illustrated and described as embodiments of an apparatus for maintaining the head of a person in an erect position when the person is sitting in a seat, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. An apparatus for maintaining the head of a person in an erect position when the person is sitting in a seat, the apparatus comprising:
a) a clamp connected to the seat;
b) a flexible rod; and
c) means for coupling an end of the flexible rod to the clamp, whereby the flexible rod can be bent to extend across the forehead of the head of the person to keep the head in the erect position especially when the person is sleeping.

2. The apparatus as recited in claim 1, wherein the coupling means comprises:
a) a collar mounted on the clamp having a transverse aperture therethrough; and
b) a spring loaded button horizontally mounted on the end of the flexible rod, whereby when the end of the flexible rod is inserted into the collar the spring loaded button will snap into the transverse aperture in the collar.

3. The apparatus as recited in claim 1, further comprising a foam cushion sleeve which fits over the flexible rod to act as a pillow.

4. The apparatus as recited in claim 3, wherein the sleeve has the length of about 2-4 feet, an outer diameter from 1.5-2 inches and inner diameter is about 1 inch.

5. The apparatus as recited in claim 3, further comprising a soft decorative cover that slips over the foam cushion sleeve, whereby the soft decorative cover.

6. The apparatus as recited in claim 5, wherein the length of the cover is about 2-4 feet and the diameter of the cover is about 2 inches.

7. The apparatus as recited in claim 1, wherein the clamp is comprised of a spring clip clamp.

8. The apparatus as recited in claim 7, wherein the size of the clamp in thickness, width, and length are 1×2×5 inches.

9. The apparatus as recited in claim 1, wherein the clamp is comprised of a C-clamp.

10. The apparatus as recited in claim 9, wherein the size of the clamp in thickness, width, and length are 1×2×5 inches.

11. The apparatus as recited in claim 1, wherein the clamp is comprised of a pipe clamp.

12. The apparatus as recited in claim 11, wherein the size of the clamp in thickness, width, and length are 1×2×5 inches.

13. The apparatus as recited in claim 12, wherein the clamp is comprised of a spring locking pliers clamp.

14. The apparatus as recited in claim 13, wherein the size of the clamp in thickness, width, and length are 1×2×5 inches.
